(19) United States
(12) Patent Application Publication
(10) Pub. No.: US 2012/0244769 A1
(43) Pub. Date: Sep. 27, 2012

(54) METHODS TO IMPROVE THE PROCESS-ABILITY OF UNI-DIRECTIONAL COMPOSITES

(75) Inventors: Henry Gerard Ardiff, Chesterfield, VA (US); Bradley Grunden, Midlothian, VA (US); Tyler Bartelt, Midlothian, VA (US)

(73) Assignee: HONEYWELL INTERNATIONAL INC., Morristown, NJ (US)

(21) Appl. No.: 13/072,523

(22) Filed: Mar. 25, 2011

(51) Int. Cl. B32B 5/26; B32B 37/02; B32B 29/02; B32B 37/14; B05D 3/00; B05D 5/00; B32B 27/12; B32B 37/12

(52) U.S. Cl. 442/57; 442/394; 442/381; 156/306.6; 156/308.2; 427/195; 156/179

(57) ABSTRACT

A method of producing composites useful for the formation of armor and armor sub-assembly intermediates. More particularly, improved ballistic resistant composites and a method for the production of ballistic resistant composites and armor sub-assembly intermediates from composites that have resin-poor surfaces resulting from the non-uniform impregnation polymeric binder materials in fiber layers.

### BACKGROUND OF THE INVENTION

1. Field of the Invention

This invention relates to a method of producing composites useful for the formation of armor and armor sub-assembly intermediates. More particularly, the invention pertains to improved ballistic resistant composites and a method for the production of ballistic resistant composites and armor sub-assembly intermediates from composites that have resin-poor surfaces resulting from the non-uniform impregnation of polymeric binder materials in fiber layers.

2. Description of the Related Art

Ballistic resistant articles containing high strength fibers that have excellent properties against projectiles are well known. Articles such as bullet resistant vests, helmets, vehicle panels and structural members of military equipment are typically made from fabrics comprising high strength fibers. High strength fibers conventionally used include polyethylene fibers, aramid fibers such as poly(phenylenediamine terephthalamide), graphite fibers, nylon fibers, glass fibers and the like. For many applications, such as vests or parts of vests, the fibers may be used in a woven or knitted fabric. For other applications, the fibers may be encapsulated or embedded in a polymeric binder material to form woven or non-woven rigid or flexible fabrics.

Non-woven, unidirectional composites of fibers impregnated with a polymeric binder material are among the highest performing materials in the armor industry, and they are particularly effective for the manufacture of personal body armor. In one method of the manufacture of personal body armor, multiple layers of a unidirectional composite are stacked together and pressed at a high temperature and high pressure to yield a rigid article, such as a breast plate or helmet. In this regard, it is known that to improve both the performance of the final article as well as manufacturing efficiencies, it can be useful to first process individual fiber layers at low or moderate temperatures, pressures and residence times into shaped sub-assemblies before processing the final article under more intense conditions.

Unfortunately, during the fabrication of precursor materials that are subsequently processed into such shaped sub-assemblies, it has been found that non-ideal processing conditions often undesirably cause a non-uniform distribution of the polymeric binder material in the composites. Depending on the particular processing conditions, such as coating technique, applied process forces and pressures (squeeze nips), process wiping (stationary metering bars), processing aids employed, gravity, surface tension, coating viscosity, coating compatibility with the fibers, non-uniformity of the fiber surface, and the order of processing, etc., composites may be fabricated having resin-rich and resin-poor/resin-lean areas, where the resin-rich areas have a greater concentration of polymeric binder material than the resin-poor areas. Typically, resin-poor areas are found at one or both of the outer surfaces with most of the polymeric binder at the interior of the composite. This results in difficulties in consolidating individual layers into sub-assemblies, and/or processing multiple sub-assemblies, under the aforementioned desirable moderate processing conditions. Compounding this problem, it is very difficult or impossible to sufficiently correct this distribution within the normal parameters of the incumbent fabrication process.

The present invention provides a process for correcting the problems associated with such non-uniform distribution by increasing the relative amount of thermoplastic resin at the surface, as opposed to in the interior, of the non-woven unidirectional composite fabric. The resulting fiber layers or composites may be adhered or bonded to other fiber layers or composites with a minimum of temperature and pressure. Importantly, the process of the invention allows for the fabrication of useful composites without strict monitoring and/or control of processing conditions that is typically required to avoid the non-uniform distribution of the polymeric binder material in the composites, and overcomes problems associated with the fabrication of fiber layers having at least one resin-poor outer surface.

### SUMMARY OF THE INVENTION

The invention provides a method of producing a composite impregnated with a non-uniformly distributed polymeric binder material, the method comprising:

a) providing a fiber layer having an outer top surface and an outer bottom surface, the fiber layer comprising a plurality of fiber plies, each of said fiber plies comprising a plurality of fibers, wherein the fiber layer is impregnated with a polymeric binder material;
b) applying a thermoplastic polymer onto said outer top surface of the fiber layer and/or said outer bottom surface of the fiber layer; and
c) bonding the thermoplastic polymer on the fiber layer to the fiber layer, wherein:
i) the thermoplastic polymer is bonded to the fiber layer before a consolidation step which consolidates the plurality of fiber plies and the polymeric binder material into a composite; or
ii) the thermoplastic polymer is bonded to the fiber layer in-line during a consolidation step which consolidates the plurality of fiber plies and the polymeric binder material into a composite; or
iii) the thermoplastic polymer is bonded to the fiber layer after a consolidation step which consolidates the plurality of fiber plies and the polymeric binder material into a composite.

The invention also provides a composite material comprising at least one fiber layer having an outer top surface and an outer bottom surface, which fiber layer comprises a plurality of fiber plies, said fiber plies each comprising a plurality of fibers having a polymeric binder material thereon, and wherein the polymeric binder material is non-uniformly distributed in the fiber layer; and a thermoplastic polymer bonded to said outer top surface of the fiber layer and/or said outer bottom surface of the fiber layer.

Also provided are armor articles or sub-assemblies of armor articles formed from these composites.

### BRIEF DESCRIPTION OF THE DRAWING

FIG. 1 is a schematic representation of three sheets of material arranged in a platen press prior to being pressed.

### DETAILED DESCRIPTION OF THE INVENTION

The invention presents a method for modifying the outer surfaces of fiber layers that are impregnated with a non-uniformly distributed polymeric binder material. A “fiber layer” as used herein may comprise a single-ply of unidirectionally oriented fibers, a plurality of non-consolidated plies of unidirectionally oriented fibers, a plurality of consolidated plies of unidirectionally oriented fibers, a woven fabric, a plurality of consolidated woven fabrics, or any other fabric structure that has been formed from a plurality of fibers, including felts, mats and other structures comprising randomly oriented fibers. A “layer” describes a generally planar arrangement. Each fiber layer will have both an outer top surface and an outer bottom surface. A “single-ply” of unidirectionally oriented fibers comprises an arrangement of non-overlapping fibers that are aligned in a unidirectional, substantially parallel array. This type of fiber arrangement is also known in the art as a “unitape” (unidirectional tape). As used herein, an “array” describes an orderly arrangement of fibers or yarns, and a “parallel array” describes an orderly parallel arrangement of fibers or yarns. The term “oriented” as used in the context of “oriented fibers” refers to the alignment of the fibers as opposed to stretching of the fibers.

For the purposes of the present invention, a “fiber” is an elongate body the length dimension of which is much greater than the transverse dimensions of width and thickness. The cross-sections of fibers for use in this invention may vary widely, and they may be circular, flat or oblong in cross-section. Thus the term “fiber” includes filaments, ribbons, strips and the like having regular or irregular cross-section, but it is preferred that the fibers have a substantially circular cross-section. As used herein, the term “yarn” is defined as a single strand consisting of multiple fibers. A single fiber may be formed from just one filament or from multiple filaments. A fiber formed from just one filament is referred to herein as either a “single-filament” fiber or a “monofilament” fiber, and a fiber formed from a plurality of filaments is referred to herein as a “multifilament” fiber.

The term “fabric” describes structures that may include one or more fiber plies, with or without molding or consolidation of the plies. For example, a woven fabric or felt may comprise a single fiber ply. A non-woven fabric formed from unidirectional fibers typically comprises a plurality of fiber plies stacked on each other and consolidated. When used herein, a “single-layer” structure refers to a monolithic structure composed of one or more individual plies, wherein multiple individual plies have been consolidated into a single unitary structure together with a polymeric binder material. By “consolidating” it is meant that the polymeric binder material together with each fiber ply is combined into a single unitary layer. Consolidation can occur via drying, cooling, heating, pressure or a combination thereof. Heat and/or pressure may not be necessary, as the fibers or fabric layers may just be glued together, as is the case in a wet lamination process. The term “composite” refers to combinations of fibers with at least one polymeric binder material. A “complex composite” as used herein refers to a consolidated combination of a plurality of fiber layers. As described herein, “non-woven” fabrics include all fabric structures that are not formed by weaving. For example, non-woven fabrics may comprise a plurality of unitapes that are at least partially coated with a polymeric binder material, stacked/overlapped and consolidated into a single-layer, monolithic element, as well as a felt or mat comprising non-parallel, randomly oriented fibers that are (preferably) coated with a polymeric binder composition. As used herein, the terms “resin-poor” or “resin-lean” are used interchangeably with “polymer-poor” or “polymer-lean”. The term “resin-rich” is used interchangeably with “polymer-rich.”

The methods described herein are particularly directed to modifying the outer surfaces of materials that are considered resin-poor or resin-lean at such surfaces. Sub-assemblies having resin-poor surfaces are difficult to tack and require high temperatures and pressures to consolidate, and such materials when unmodified do not process well as armor sub-assemblies useful for the production of armor articles. A fusible thermoplastic layer applied to the resin-poor surfaces will increase the tack of one or both sides of the fabric layer which, improving its ability to be merged with other fabric layers and shaped into a sub-assembly, as well as allowing lower temperatures and pressures to be used when forming the sub-assembly. Accordingly, the methods of the invention are particularly useful for the production of materials having better processability as armor sub-assemblies.

The thermoplastic polymer is applied onto a plurality of fibers that are arranged as a fiber layer but which may or may not be considered to be a fabric at the time of coating. Either one or both outer surfaces of a fiber layer may be treated depending on need, such as if only one surface is resin-poor. The modified materials, modified with this additional thermoplastic material on the resin-poor surfaces, will process better at moderate conditions. For helmet intermediate sub-assemblies, moderate temperatures are those well below the molding temperature of the final helmet and can be considered as parameters that are easily attainable in a relatively short period of time. For example, a sub-assembly of multiple layers of a first material may be pre-formed into a helmet shape with the subsequent addition of additional layers of the same material, or of a different material. Typically, the sub-assemblies are processed by building up and pre-forming/consolidating single (2-ply or 4-ply) fiber layers or two fiber layers at a time using pressures as low as 30-60 psi (206.8 kPa-413.7 kPa) and at temperatures of from about 100° F. (37.8° C.) to about 220° F. (104.4° C.), more typically from about 130° F. (54.4° C.) to about 220° F. with varying residence times. Sub-assemblies are preferably processed at a pressure of from about 30 psi to about 500 psi (3,447 kPa), more preferably from about 30 psi to about 325 psi (2,241 kPa), more preferably from about 30 psi to about 150 psi (1,034 kPa) and most preferably from about 30 psi to about 60 psi. Typical processing residence time at such moderate consolidation conditions is about 30 seconds per added single or double ply. However, the appropriate pressures and temperatures will vary by material. For example, matrix materials having a higher melting point may not process well at these temperatures. Appropriate molding pressures and temperatures may also vary by article design, and may also affect fiber wetting/bonding, adhesion between dissimilar materials, density, void inclusion, as well as mechanical or crystalline structure of the high performance fibers.

Thereafter, various sub-assemblies are co-processed into a final article at higher temperatures and pressures. Final helmet molding temperatures are generally higher. For example, a typical molding temperature for a final helmet is about 300° F. (148.9° C.). Helmets produced using woven phenolic aramid based materials are processed at 320° F. (160° C.). Polyethylene based unidirectional materials are processed at about 280° F. (137.8° C.). Exemplary conditions for molding a helmet could be molding into a helmet shape at 300° F. (148.9° C.) and 5,000 psi (34.47 MPa) for 20 minutes. However, the conditions will again vary by material, etc. It should also be understood that while reference is made throughout this disclosure to the molding of helmets and helmet sub-assembly intermediates, the same conditions apply the production of any armor article or shape and their respective sub-assembly intermediates as would be conducted by one skilled in the art.

Processing of armor sub-assemblies at moderate temperatures is desired because there is a reduced likelihood of thermal damage to any of the unconstrained components of the sub-assembly during processing. Moderate pressures can be achievable with less capable equipment, that which is dedicated to the production of sub-assemblies, such as 500 psi for a sub-assembly machine versus 5,000 psi for a final production press. Another benefit is of pre-forming sub-assemblies is the reduction of residence time during consolidation. As the composite fabrics are usually good thermal insulators, it is time consuming to thoroughly heat an entire sub-assembly (rather than component fiber layers of a sub-assembly) to a high temperature, especially through surface conduction. Heating the component fiber layers up to 220° F. (104.4° C.) is significantly faster than heating a fully assembled sub-assembly up to 300° F. (148.9° C.). Multiple sub-assemblies may then be consolidated into a complex armor structure, such as a helmet, where the supplemental resin is thereby positioned primarily in the interior of the structure between adjacent sub-assemblies.

Several different approaches may be effectively employed to increase the amount of thermoplastic resin or binder at resin-poor surfaces of non-woven unidirectional composite fabrics, some in-line during the process step of laminating multiple fiber plies together to form a fiber layer, or through a secondary application technique whereby the laminated product undergoes a subsequent process step. For example, one preferred method is to lay a separate thermoplastic web onto the resin-poor side of the fabric and to bond it to the fabric. This web can be a continuous thermoplastic film, an ordered discontinuous thermoplastic net, or a non-woven discontinuous fabric or scrim. Bonding to the fabric may be accomplished by a variety of methods including, but not limited to, thermal lamination through a calender nip or a flat-bed laminator, or wet lamination as part of the coating process where the resin binder is applied to the fiber. Alternately, a coating of fusible powder of a thermoplastic resin or binder may be applied to the resin-poor surface, with subsequent bonding, melting and/or fusing of the powder to the surface, such as via a flat-bed laminator. These preferred methods are only non-limiting examples of potential techniques and are not intended to be a comprehensive listing of all useful methods for accomplishing the stated goals. After application and/or before bonding of the thermoplastic layer to a fiber layer, the thermoplastic layer may be tacky at the processing temperature employed such that it is capable of adhering adjacent layers without heating of the thermoplastic layer or fiber layer, and with minimal pressure. However, the thermoplastic polymer is typically non-tacky at room temperature or other typical storage conditions.

The method of the invention may also be utilized to modify surfaces of fiber layers that are not impregnated with a polymeric binder material, or fiber layers that are either fully saturated with a polymeric binder material that has a high softening temperature, or having a uniform distribution of polymeric binder that has a high softening temperature, it is more specifically intended for modifying fiber layers that are impregnated with a polymeric binder material, such as typical non-woven fabrics, where the binder is non-uniformly distributed therein and having one or more resin-poor surfaces. The method of the invention is also useful for modifying fiber layers that have a uniform distribution of polymeric binder but where the surfaces are resin-poor and not suitable for the fabrication of sub-assemblies as discussed herein. Depending on the particular processing conditions of such impregnated fabrics, conditions such as coating technique, processing aids employed, gravity, surface tension, order of processing, resin distribution on the fiber layer, resin volume fraction, and resin properties such as the resin softening point, all factor into the fabrication of composites having a non-uniform distribution of the polymeric binder material characterized by the presence of resin-rich and resin-poor/resin-lean areas. Most typically, these conditions result in the resin-poor areas being located at the outer surfaces with most of the polymeric binder at the interior of the composite. Accordingly, the primary need for the thermoplastic polymer is on the outer top surface of the fiber layer and/or said outer bottom surface of the fiber layer.

Bonding of the thermoplastic polymer to the fiber layer may generally take place at any stage of the process. For example, the thermoplastic polymer may be bonded to the fiber layer before a consolidation step which consolidates the plurality of fiber plies and the polymeric binder material into a composite, in-line during a consolidation step which consolidates the plurality of fiber plies and the polymeric binder material into a composite, or after a consolidation step which consolidates the plurality of fiber plies and the polymeric binder material into a composite.

The fiber layers and composites formed therefrom preferably comprise ballistic resistant composites formed from high-strength, high tensile modulus polymeric fibers. Most preferably, the fibers comprise high strength, high tensile modulus fibers which are useful for the formation of ballistic resistant materials and articles. As used herein, a “high-strength, high tensile modulus fiber” is one which has a preferred tenacity of at least about 7 g/denier or more, a preferred tensile modulus of at least about 150 g/denier or more, and preferably an energy-to-break of at least about 8 J/g or more, each both as measured by ASTM D2256. As used herein, the term “denier” refers to the unit of linear density, equal to the mass in grams per 9000 meters of fiber or yarn. As used herein, the term “tenacity” refers to the tensile stress expressed as force (grams) per unit linear density (denier) of an unstressed specimen. The “initial modulus” of a fiber is the property of a material representative of its resistance to deformation. The term “tensile modulus” refers to the ratio of the change in tenacity, expressed in grams-force per denier (g/d) to the change in strain, expressed as a fraction of the original fiber length (in/in).

The polymers forming the fibers are preferably high-strength, high tensile modulus fibers suitable for the manufacture of ballistic resistant composites/fabrics. Particularly suitable high-strength, high tensile modulus fiber materials that are particularly suitable for the formation of ballistic resistant composites and articles include polyolefin fibers, including high density and low density polyethylene. Particularly preferred are extended chain polyolefin fibers, such as highly oriented, high molecular weight polyethylene fibers, particularly ultra-high molecular weight polyethylene fibers, and polypropylene fibers, particularly ultra-high molecular weight polypropylene fibers. Also suitable are aramid fibers, particularly para-aramid fibers, polyamide fibers, polyethylene terephthalate fibers, polyethylene naphthalate fibers, extended chain polyvinyl alcohol fibers, extended chain polyacrylonitrile fibers, polybenzazole fibers, such as polybenzoxazole (PBO) and polybenzothiazole (PBT) fibers, liquid crystal copolyester fibers and rigid rod fibers such as M5® fibers. Each of these fiber types is conventionally known in the art. Also suitable for producing polymeric fibers are copolymers, block polymers and blends of the above materials.

The most preferred fiber types for ballistic resistant fabrics include polyethylene, particularly extended chain polyethylene fibers, aramid fibers, polybenzazole fibers, liquid crystal copolyester fibers, polypropylene fibers, particularly highly oriented extended chain polypropylene fibers, polyvinyl alcohol fibers, polyacrylonitrile fibers and rigid rod fibers, particularly M5® fibers. Specifically most preferred fibers are aramid fibers.

In the case of polyethylene, preferred fibers are extended chain polyethylenes having molecular weights of at least 500,000, preferably at least one million and more preferably between two million and five million. Such extended chain polyethylene (ECPE) fibers may be grown in solution spinning processes such as described in U.S. Pat. No. 4,137,394 or 4,356,138, which are incorporated herein by reference, or may be spun from a solution to form a gel structure, such as described in U.S. Pat. Nos. 4,551,296 and 5,006,390, which are also incorporated herein by reference. A particularly preferred fiber type for use in the invention are polyethylene fibers sold under the trademark SPECTRA® from Honeywell International Inc. SPECTRA® fibers are well known in the art and are described, for example, in U.S. Pat. Nos. 4,623,547 and 4,748,064. In addition to polyethylene, another useful polyolefin fiber type is polypropylene (fibers or tapes), such as TEGRIS® fibers commercially available from Milliken & Company of Spartanburg, S.C.

Also particularly preferred are aramid (aromatic polyamide) or para-aramid fibers. Such are commercially available and are described, for example, in U.S. Pat. No. 3,671,542. For example, useful poly(p-phenylene terephthalamide) filaments are produced commercially by DuPont under the trademark of KEVLAR®. Also useful in the practice of this invention are poly(m-phenylene isophthalamide) fibers produced commercially by DuPont under the trademark NOMEX® and fibers produced commercially by Teijin under the trademark TWARON®; aramid fibers produced commercially by Kolon Industries, Inc. of Korea under the trademark HERACRON®; p-aramid fibers SVM™ and RUSAR™ which are produced commercially by Kamensk Volokno JSC of Russia and ARMOS™ p-aramid fibers produced commercially by JSC Chim Volokno of Russia.

Suitable polybenzazole fibers for the practice of this invention are commercially available and are disclosed for example in U.S. Pat. Nos. 5,286,833, 5,296,185, 5,356,584, 5,534,205 and 6,040,050, each of which is incorporated herein by reference. Suitable liquid crystal copolyester fibers for the practice of this invention are commercially available and are disclosed, for example, in U.S. Pat. Nos. 3,975,487; 4,118,372 and 4,161,470, each of which is incorporated herein by reference. Suitable polypropylene fibers include highly oriented extended chain polypropylene (ECPP) fibers as described in U.S. Pat. No. 4,413,110, which is incorporated herein by reference. Suitable polyvinyl alcohol (PV-OH) fibers are described, for example, in U.S. Pat. Nos. 4,440,711 and 4,599,267 which are incorporated herein by reference. Suitable polyacrylonitrile (PAN) fibers are disclosed, for example, in U.S. Pat. No. 4,535,027, which is incorporated herein by reference. Each of these fiber types is conventionally known and is widely commercially available.

M5® fibers are formed from pyridobisimidazole-2,6-diyl (2,5-dihydroxy-p-phenylene) and are manufactured by Magellan Systems International of Richmond, Va. and are described, for example, in U.S. Pat. Nos. 5,674,969, 5,939,553, 5,945,537, and 6,040,478, each of which is incorporated herein by reference. Also suitable are combinations of all the above materials, all of which are commercially available. For example, the fibrous layers may be formed from a combination of one or more of aramid fibers, UHMWPE fibers (e.g. SPECTRA® fibers), carbon fibers, etc., as well as fiberglass and other lower-performing materials.

The fibers may be of any suitable denier, such as, for example, 50 to about 3000 denier, more preferably from about 200 to 3000 denier, still more preferably from about 650 to about 2000 denier, and most preferably from about 800 to about 1500 denier. The selection is governed by considerations of ballistic effectiveness and cost. Finer fibers are more costly to manufacture and to weave, but can produce greater ballistic effectiveness per unit weight.

As stated above, a high-strength, high tensile modulus fiber is one which has a preferred tenacity of about 7 g/denier or more, a preferred tensile modulus of about 150 g/denier or more and a preferred energy-to-break of about 8 J/g or more, each as measured by ASTM D2256. In the preferred embodiment of the invention, the tenacity of the fibers should be about 15 g/denier or more, preferably about 20 g/denier or more, more preferably about 25 g/denier or more and most preferably about 30 g/denier or more. Preferred fibers also have a preferred tensile modulus of about 300 g/denier or more, more preferably about 400 g/denier or more, more preferably about 500 g/denier or more, more preferably about 1,000 g/denier or more and most preferably about 1,500 g/denier or more. Preferred fibers also have a preferred energy-to-break of about 15 J/g or more, more preferably about 25 J/g or more, more preferably about 30 J/g or more and most preferably have an energy-to-break of about 40 J/g or more. These combined high strength properties are obtainable by employing well known processes. U.S. Pat. Nos. 4,413,110, 4,440,711, 4,535,027, 4,457,985, 4,623,547 4,650,710 and 4,748,064 generally discuss the formation of preferred high strength, extended chain polyethylene fibers. Such methods, including solution grown or gel fiber processes, are well known in the art. Methods of forming each of the other preferred fiber types, including para-aramid fibers, are also conventionally known in the art, and the fibers are commercially available.

The polymeric binder impregnating the fiber layers either partially or substantially coats the individual fibers of the fiber layers. In a typical process, the polymeric binder becomes non-uniformly distributed in a fiber layer largely due to the effects of gravity and surface tension, among other factors previously mentioned. For example, in one process of forming non-woven fiber layers from a plurality of unidirectional fiber plies (unitapes), the polymeric binder is applied to a first ply and then, while the coated fiber ply is still wet, it is contacted with a disposable silicone-coated release paper. The wet resin typically will not distribute itself uniformly throughout the thickness of the unidirectional fiber web because gravity and the difference in surface tension between the silicone-coated paper on one side and the air on the other side causes a concentration gradient through the thickness, with the filaments adjacent to the release paper being heavily saturated with resin and the filaments exposed to the air being resin-lean. Next, a second wet, coated fiber web is contacted at an angle (typically 90°) with the resin-lean side of the first, now dried, fiber ply. The wet resin will again distribute itself non-uniformly, with a higher concentration of resin at the interface of the two orthogonal) (0°/90° fiber plies and the air-side or top-side (outer top surface) being resin-lean due to these conditions. While this process is exemplified for an embodiment where the polymeric binder is non-uniformly distributed in the fiber layers, it is not intended to be mandatory or limiting. The polymeric binder material may be non-uniformly distributed within the fiber layer either prior to, during or after the application of the thermoplastic polymer to the fiber layer, as well as prior to, during or after bonding of the thermoplastic polymer to the fiber layer.

The polymeric binder material is also commonly known in the art as a “polymeric matrix” material, and these terms are used interchangeably herein. These terms are conventionally known in the art and describe a material that binds fibers together either by way of its inherent adhesive characteristics or after being subjected to well known heat and/or pressure conditions. Such a “polymeric matrix” or “polymeric binder” material may also provide a fabric with other desirable properties, such as abrasion resistance and resistance to deleterious environmental conditions, so it may be desirable to coat the fibers with such a binder material even when its binding properties are not important, such as with woven fabrics. It is generally not possible to form sub-assemblies from woven fabrics unless they are impregnated or coated with some form of polymeric binder material. Accordingly, for the purposes of this invention, the methods of the invention are directed to woven fabrics that either are not impregnated with a binder, or when impregnated, have resin-poor areas or surfaces similar to non-woven fabrics described herein that impede the consolidation of multiple sub-assemblies. To merge multiple woven fabrics, the fibers comprising the woven fabrics are at least partially coated with a polymeric binder, followed by a consolidation step similar to that conducted with non-woven fiber layers. Such a consolidation step may be conducted to merge multiple woven fiber layers with each other, or to further impregnate the woven fabric with the binder material.

Suitable polymeric binder materials include both low modulus, elastomeric materials and high modulus, rigid materials. As used herein throughout, the term tensile modulus means the modulus of elasticity as measured by ASTM 2256 for a fiber and by ASTM D638 for a polymeric binder material. A low or high modulus binder may comprise a variety of polymeric and non-polymeric materials. A preferred polymeric binder comprises a low modulus elastomeric material. For the purposes of this invention, a low modulus elastomeric material has a tensile modulus measured at about 6,000 psi (41.4 MPa) or less according to ASTM D638 testing procedures. A low modulus polymer preferably has, the tensile modulus of the elastomer is about 4,000 psi (27.6 MPa) or less, more preferably about 2400 psi (16.5 MPa) or less, more preferably 1200 psi (8.23 MPa) or less, and most preferably is about 500 psi (3.45 MPa) or less. The glass transition temperature (Tg) of the elastomer is preferably less than about 0° C., more preferably the less than about −40° C., and most preferably less than about −50° C. The elastomer also has a preferred elongation to break of at least about 50%, more preferably at least about 100% and most preferably has an elongation to break of at least about 300%.

A wide variety of materials and formulations having a low modulus may be utilized as the polymeric binder. Representative examples include polybutadiene, polyisoprene, natural rubber, ethylene-propylene copolymers, ethylene-propylene-diene terpolymers, polysulfide polymers, polyurethane elastomers, chlorosulfonated polyethylene, polychloroprene, plasticized polyvinylchloride, butadiene acrylonitrile elastomers, poly(isobutylene-co-isoprene), polyacrylates, polyesters, polyethers, fluoroelastomers, silicone elastomers, copolymers of ethylene, polyamides (useful with some fiber types), acrylonitrile butadiene styrene, polycarbonates, and combinations thereof, as well as other low modulus polymers and copolymers curable below the melting point of the fiber. Also preferred are blends of different elastomeric materials, or blends of elastomeric materials with one or more thermoplastics.

Particularly useful are block copolymers of conjugated dienes and vinyl aromatic monomers. Butadiene and isoprene are preferred conjugated diene elastomers. Styrene, vinyl toluene and t-butyl styrene are preferred conjugated aromatic monomers. Block copolymers incorporating polyisoprene may be hydrogenated to produce thermoplastic elastomers having saturated hydrocarbon elastomer segments. The polymers may be simple tri-block copolymers of the type A-B-A, multi-block copolymers of the type (AB)ₙ (n=2-10) or radial configuration copolymers of the type R-(BA)ₓ (x=3-150); wherein A is a block from a polyvinyl aromatic monomer and B is a block from a conjugated diene elastomer. Many of these polymers are produced commercially by Kraton Polymers of Houston, Tex. and described in the bulletin “Kraton Thermoplastic Rubber”, SC-68-81. Also useful are resin dispersions of styrene-isoprene-styrene (SIS) block copolymer sold under the trademark PRINLIN® and commercially available from Henkel Technologies, based in Dusseldorf, Germany. The most preferred low modulus polymeric binder polymer comprises styrenic block copolymers sold under the trademark KRATON® commercially produced by Kraton Polymers. The most preferred polymeric binder material comprises a polystyrene-polyisoprene-polystrene-block copolymer sold under the trademark KRATON®.

While low modulus polymeric matrix binder materials are most useful for the formation of flexible armor, such as ballistic resistant vests, high modulus, rigid materials useful for forming hard armor articles, such as helmets, are particularly preferred herein. Preferred high modulus, rigid materials generally have a higher initial tensile modulus than 6,000 psi. Preferred high modulus, rigid polymeric binder materials useful herein include polyurethanes (both ether and ester based), epoxies, polyacrylates, phenolic/polyvinyl butyral (PVB) polymers, vinyl ester polymers, styrene-butadiene block copolymers, as well as mixtures of polymers such as vinyl ester and diallyl phthalate or phenol formaldehyde and polyvinyl butyral. A particularly preferred rigid polymeric binder material for use in this invention is a thermosetting polymer, preferably soluble in carbon-carbon saturated solvents such as methyl ethyl ketone, and possessing a high tensile modulus when cured of at least about 1×10⁶ psi (6895 MPa) as measured by ASTM D638. Particularly preferred rigid polymeric binder materials are those described in U.S. Pat. No. 6,642,159, the disclosure of which is incorporated herein by reference. The polymeric binder, whether a low modulus material or a high modulus material, may also include fillers such as carbon black or silica, may be extended with oils, or may be vulcanized by sulfur, peroxide, metal oxide or radiation cure systems as is well known in the art. Most specifically preferred are polyurethane polymeric matrix binders within the range of both soft and rigid materials at a modulus ranging from about 2,000 psi (13.79 MPa) to about 8,000 psi (55.16 MPa).

The rigidity, impact and ballistic properties of the articles formed from the composites of the invention are affected by the tensile modulus of the polymeric binder polymer coating the fibers. For example, U.S. Pat. No. 4,623,574 discloses that fiber reinforced composites constructed with elastomeric matrices having tensile moduli less than about 6,000 psi (41,300 kPa) have superior ballistic properties compared both to composites constructed with higher modulus polymers, and also compared to the same fiber structure without a polymeric binder material. However, low tensile modulus polymeric binder material polymers also yield lower rigidity composites. Further, in certain applications, particularly those where a composite must function in both anti-ballistic and structural modes, there is needed a superior combination of ballistic resistance and rigidity. Accordingly, the most appropriate type of polymeric binder polymer to be used will vary depending on the type of article to be formed from the composites of the invention. In order to achieve a compromise in both properties, a suitable polymeric binder may combine both low modulus and high modulus materials to form a single polymeric binder.

The polymeric binder material may be applied either simultaneously or sequentially to a plurality of fibers arranged as a fiber web (e.g. a parallel array or a felt) to form a coated web, applied to a woven fabric to form a coated woven fabric, or as another arrangement, to thereby impregnate the fiber layers with the binder. As used herein, the term “impregnated with” is synonymous with “embedded in” as well as “coated with” or otherwise applied with the coating where the binder material diffuses into the fiber layer and is not simply on a surface of the fiber layers. The polymeric material may also be applied onto at least one array of fibers that is not part of a fiber web, followed by weaving the fibers into a woven fabric or followed by formulating a non-woven fabric following the methods described previously herein. Techniques of forming woven and non-woven fiber plies, layers and fabrics are well known in the art.

Although not required, fibers forming woven fiber layers are at least partially coated with a polymeric binder, followed by a consolidation step similar to that conducted with non-woven fiber layers. Such a consolidation step may be conducted to merge multiple woven fiber layers with each other, or to further merge the binder with the fibers of said woven fabric. For example, a plurality of woven fiber layers do not necessarily have to be consolidated, and may be attached by other means, such as with a conventional adhesive, or by stitching.

Generally, a polymeric binder coating is necessary to efficiently merge, i.e. consolidate, a plurality of non-woven fiber plies. The polymeric binder material may be applied onto the entire surface area of the individual fibers or only onto a partial surface area of the fibers. Most preferably, the coating of the polymeric binder material is applied onto substantially all the surface area of each individual fiber forming a fiber layer of the invention. Where a fiber layer comprises a plurality of yarns, each fiber forming a single strand of yarn is preferably coated with the polymeric binder material.

Any appropriate application method may be utilized to apply the polymeric binder material and the term “coated” is not intended to limit the method by which the polymer layers are applied onto the filaments/fibers. The polymeric binder material is applied directly onto the fiber surfaces using any appropriate method that would be readily determined by one skilled in the art, and the binder then typically diffuses into the fiber layer as discussed herein. For example, the polymeric binder materials may be applied in solution, emulsion or dispersion form by spraying, extruding or roll coating a solution of the polymer material onto fiber surfaces, wherein a portion of the solution comprises the desired polymer or polymers and a portion of the solution comprises a solvent capable of dissolving or dispersing the polymer or polymers, followed by drying. Alternately, the polymeric binder material may be extruded onto the fibers using conventionally known techniques, such as through a slot-die, or through other techniques such as direct gravure, Meyer rod and air knife systems, which are well known in the art. Another method is to apply a neat polymer of the binder material onto fibers either as a liquid, a sticky solid or particles in suspension or as a fluidized bed. Alternatively, the coating may be applied as a solution, emulsion or dispersion in a suitable solvent which does not adversely affect the properties of fibers at the temperature of application. For example, the fibers can be transported through a solution of the polymeric binder material to substantially coat the fibers and then dried.

In another coating technique, the fibers may be dipped into a bath of a solution containing the polymeric binder material dissolved or dispersed in a suitable solvent, and then dried through evaporation or volatilization of the solvent. This method preferably at least partially coats each individual fiber with the polymeric material, preferably substantially coating or encapsulating each of the individual fibers and covering all or substantially all of the filament/fiber surface area with the polymeric binder material. The dipping procedure may be repeated several times as required to place a desired amount of polymer material onto the fibers.

Other techniques for applying a coating to the fibers may be used, including coating of a gel fiber precursor when appropriate, such as by passing the gel fiber through a solution of the appropriate coating polymer under conditions to attain the desired coating. Alternatively, the fibers may be extruded into a fluidized bed of an appropriate polymeric powder.

The fibers may be coated with the polymeric binder either before or after the fibers are arranged into one or more plies/layers, or before or after the fibers are woven into a woven fabric. Woven fabrics may be formed using techniques that are well known in the art using any fabric weave, such as plain weave, crowfoot weave, basket weave, satin weave, twill weave and the like. Plain weave is most common, where fibers are woven together in an orthogonal 0°/90° orientation. Either prior to or after weaving, the individual fibers of each woven fabric material may or may not be coated with the polymeric binder material. Typically, weaving of fabrics is performed prior to coating fibers with the polymeric binder, where the woven fabrics are thereby impregnated with the binder. However, the invention is not intended to be limited by the stage at which the polymeric binder is applied to the fibers, nor by the means used to apply the polymeric binder.

Methods for the production of non-woven fabrics are well known in the art. In the preferred embodiments herein, a plurality of fibers are arranged into at least one array, typically being arranged as a fiber web comprising a plurality of fibers aligned in a substantially parallel, unidirectional array. In a typical process for forming non-woven unidirectionally aligned fiber plies, fiber bundles are supplied from a creel and led through guides and one or more spreader bars into a collimating comb, followed by coating the fibers with a polymeric binder material. A typical fiber bundle will have from about 30 to about 2000 individual fibers. The spreader bars and collimating comb disperse and spread out the bundled fibers, reorganizing them side-by-side in a coplanar fashion. Ideal fiber spreading results in the individual filaments or individual fibers being positioned next to one another in a single fiber plane, forming a substantially unidirectional, parallel array of fibers without fibers overlapping each other. At this point, scouring the fibers before or during this spreading step may enhance and accelerate the spreading of the fibers into such a parallel array. Fiber scouring is a process in which fibers (or fabric) are passed through a chemical solution which removes any of the undesirable residual fiber finish (or weaving aid) that may have been applied to the fibers during or after fabrication. Fiber scouring may also improve the bond strength of a subsequently applied polymeric binder material (or a subsequently applied protective film) on the fibers, and accordingly, less binder may be needed. By reducing amount of binder, a greater number of fibers may be included in a fabric, producing a lighter ballistic material with improved strength. This also leads to increased projectile engagement with the fibers, improved stab resistance of resulting fabric composites and an increased resistance of the composites against repeated impacts. Following fiber spreading and collimating, the fibers of such a parallel array typically contain from about 3 to 12 fiber ends per inch (1.2 to 4.7 ends per cm), depending on the filament/fiber thickness.

After the fibers are coated with the binder material, the coated fibers are formed into non-woven fiber layers that comprise a plurality of overlapping, non-woven fiber plies that are consolidated into a single-layer, monolithic element. In a preferred non-woven fabric structure of the invention, a plurality of stacked, overlapping unitapes are formed wherein the parallel fibers of each single ply (unitape) are positioned orthogonally to the parallel fibers of each adjacent single ply relative to the longitudinal fiber direction of each single ply. The stack of overlapping non-woven fiber plies is consolidated under heat and pressure, or by adhering the coatings of individual fiber plies, to form a single-layer, monolithic element which has also been referred to in the art as a single-layer, consolidated network where a “consolidated network” describes a consolidated (merged) combination of fiber plies with the polymeric matrix/binder. Articles of the invention may also comprise hybrid consolidated combinations of woven fabrics and non-woven fabrics, as well as combinations of non-woven fabrics formed from unidirectional fiber plies and non-woven felt fabrics.

Most typically, non-woven fiber layers or fabrics include from 1 to about 6 plies, but may include as many as about 10 to about 20 plies as may be desired for various applications. The greater the number of plies translates into greater ballistic resistance, but also greater weight. Accordingly, the number of fiber plies forming a fiber layer composite and/or fabric composite or an article of the invention varies depending upon the ultimate use of the fabric or article. For example, in body armor vests for military applications, in order to form an article composite that achieves a desired 1.0 pound per square foot or less areal density (4.9 kg/m²), a total of about 100 plies (or layers) to about 50 individual plies (or layers) may be required, wherein the plies/layers may be woven, knitted, felted or non-woven fabrics (with parallel oriented fibers or other arrangements) formed from the high-strength fibers described herein. In another embodiment, body armor vests for law enforcement use may have a number of plies/layers based on the National Institute of Justice (NIJ) Threat Level. For example, for an NIJ Threat Level IIIA vest, there may be a total of 40 plies. For a lower NIJ Threat Level, fewer plies/layers may be employed. The invention allows for the incorporation of a greater number of fiber plies to achieve the desired level of ballistic protection without increasing the fabric weight as compared to other known ballistic resistant structures.

As is conventionally known in the art, excellent ballistic resistance is achieved when individual fiber plies are cross-plied such that the fiber alignment direction of one ply is rotated at an angle with respect to the fiber alignment direction of another ply. Most preferably, the fiber plies are cross-plied orthogonally at 0° and 90° angles, but adjacent plies can be aligned at virtually any angle between about 0° and about 90° with respect to the longitudinal fiber direction of another ply. For example, a five ply non-woven structure may have plies oriented at a 0°/45°/90°/45°/0° or at other angles. Such rotated unidirectional alignments are described, for example, in U.S. Pat. Nos. 4,457,985; 4,748,064; 4,916,000; 4,403,012; 4,623,574; and 4,737,402, all of which are incorporated herein by reference to the extent not incompatible herewith.

Methods of consolidating fiber plies to form fiber layers and composites are well known, such as by the methods described in U.S. Pat. No. 6,642,159. Consolidation can occur via drying, cooling, heating, pressure or a combination thereof. Heat and/or pressure may not be necessary, as the fibers or fabric layers may just be glued together, as is the case in a wet lamination process. Typically, consolidation is done by positioning the individual fiber plies on one another under conditions of sufficient heat and pressure to cause the plies to combine into a unitary fabric. Consolidation may be done at temperatures ranging from about 50° C. to about 175° C., preferably from about 105° C. to about 175° C., and at pressures ranging from about 5 psig (0.034 MPa) to about 2500 psig (17 MPa), for from about 0.01 seconds to about 24 hours, preferably from about 0.02 seconds to about 2 hours. When heating, it is possible that the polymeric binder coating can be caused to stick or flow without completely melting. However, generally, if the polymeric binder material is caused to melt, relatively little pressure is required to form the composite, while if the binder material is only heated to a sticking point, more pressure is typically required. As is conventionally known in the art, consolidation may be conducted in a calender set, a flat-bed laminator, a press or in an autoclave. Most commonly, a plurality of orthogonal fiber webs are “glued” together with the binder polymer and run through a flat bed laminator to improve the uniformity and strength of the bond. Further, the consolidation and polymer application/bonding steps may comprise two separate steps or a single consolidation/lamination step.

Alternately, consolidation may be achieved by molding under heat and pressure in a suitable molding apparatus. Generally, molding is conducted at a pressure of from about 50 psi (344.7 kPa) to about 5,000 psi (34,470 kPa), more preferably about 100 psi (689.5 kPa) to about 3,000 psi (20,680 kPa), most preferably from about 150 psi (1,034 kPa) to about 1,500 psi (10,340 kPa). Molding may alternately be conducted at higher pressures of from about 5,000 psi (34,470 kPa) to about 15,000 psi (103,410 kPa), more preferably from about 750 psi (5,171 kPa) to about 5,000 psi, and more preferably from about 1,000 psi to about 5,000 psi. The molding step may take from about 4 seconds to about 45 minutes. Preferred molding temperatures range from about 200° F. (˜93° C.) to about 350° F. (˜177° C.), more preferably at a temperature from about 200° F. to about 300° F. and most preferably at a temperature from about 200° F. to about 280° F. The pressure under which the fiber layers and fabric composites of the invention are molded has a direct effect on the stiffness or flexibility of the resulting molded product. Particularly, the higher the pressure at which they are molded, the higher the stiffness, and vice-versa. In addition to the molding pressure, the quantity, thickness and composition of the fiber plies and polymeric binder coating type also directly affects the stiffness of the articles formed from the composites.

While each of the molding and consolidation techniques described herein are similar, each process is different. Particularly, molding is a batch process and consolidation is a generally continuous process. Further, molding typically involves the use of a mold, such as a shaped mold or a match-die mold when forming a flat panel, and does not necessarily result in a planar product. Normally consolidation is done in a flat-bed laminator, a calendar nip set or as a wet lamination to produce soft (flexible) body armor fabrics. Molding is typically reserved for the manufacture of hard armor, e.g. rigid plates. In either process, suitable temperatures, pressures and times are generally dependent on the type of polymeric binder coating materials, polymeric binder content, process used and fiber type.

To produce a fabric article having sufficient ballistic resistance properties, the total weight of the binder/matrix coating preferably comprises from about 2% to about 50% by weight, more preferably from about 5% to about 30%, more preferably from about 7% to about 20%, and most preferably from about 11% to about 16% by weight of the fibers plus the weight of the coating, wherein 16% is most preferred for non-woven fabrics. A lower binder/matrix content is appropriate for woven fabrics, wherein a polymeric binder content of greater than zero but less than 10% by weight of the fibers plus the weight of the coating is typically most preferred. This is not intended as limiting. For example, phenolic/PVB impregnated woven aramid fabrics are sometimes fabricated with a higher resin content of from about 20% to about 30%, although around 12% content is typically preferred.

Either prior to, during or after consolidation of non-woven fiber layers, or after weaving of woven fiber layers, the thermoplastic polymer is applied onto the outer top surface of the fiber layer and/or the outer bottom surface of the fiber layer when the respective surfaces are resin-lean. This will increase the amount of thermoplastic resin or binder at the resin-poor surface of the fiber layer. Several different approaches could be employed, some in-line during the current process step which laminates multiple cross-plies of product together, or through a secondary application technique whereby the laminated product undergoes a subsequent process step. One method is to lay a second thermoplastic web onto the resin-poor side of the fabric and to bond it to the fabric. This web can be a continuous thermoplastic film, an ordered discontinuous thermoplastic net, or a non-woven discontinuous fabric or scrim. The bonding can be accomplished by a variety of methods including, but not limited to, thermal lamination through a calender nip or a flat-bed laminator, and wet lamination as part of the coating process where the resin binder is applied to the fiber. Another useful method is to apply a powder coating of a thermoplastic resin or binder to the resin-poor surface, with the subsequent bonding or fusing of the powder to the surface with a flat-bed laminator. These methods are non-limiting representative examples of potential techniques and not a comprehensive listing of all useful methods. Most preferably the thermoplastic polymer is a heat-activated, non-woven, adhesive web, such as SPUNFAB®, commercially available from Keuchel Associates, Inc. of Cuyahoga Falls, Ohio; THERMOPLAST™ and HELIOPLAST™ webs, nets and films, commercially available from Protechnic S.A. of Cernay, France; as well as others. It should be further understood that the fiber ply/fiber layer consolidation and polymer application/bonding steps may comprise either two separate steps or a single consolidation/lamination step.

Suitable polymers for the thermoplastic polymer layer non-exclusively include thermoplastic polymers non-exclusively may be selected from the group consisting of polyolefins, polyamides, polyesters (particularly polyethylene terephthalate (PET) and PET copolymers), polyurethanes, vinyl polymers, ethylene vinyl alcohol copolymers, ethylene octane copolymers, acrylonitrile copolymers, acrylic polymers, vinyl polymers, polycarbonates, polystyrenes, fluoropolymers and the like, as well as co-polymers and mixtures thereof, including ethylene vinyl acetate (EVA) and ethylene acrylic acid. Also useful are natural and synthetic rubber polymers. Of these, polyolefin and polyamide layers are preferred. The preferred polyolefin is a polyethylene. Non-limiting examples of useful polyethylenes are low density polyethylene (LDPE), linear low density polyethylene (LLDPE), Medium Density Polyethylene (MDPE), linear medium density polyethylene (LMDPE), linear very-low density polyethylene (VLDPE), linear ultra-low density polyethylene (ULDPE), high density polyethylene (HDPE) and co-polymers and mixtures thereof. Of these, the most preferred polyethylene is MDPE. Of all the above, most preferred is a polyamide web, particularly SPUNFAB® polyamide webs. SPUNFAB® polyamide webs have a melting point of typically from about 75° C. to about 200° C., but this is not limiting.

As stated above, the thermoplastic polymer is preferably bonded to the fiber layer using well known techniques, such as thermal lamination. Typically, laminating is done by positioning the individual layers on one another under conditions of sufficient heat and pressure to cause the layers to combine into a unitary film. The individual layers are positioned on one another, and the combination is then typically passed through the nip of a pair of heated laminating rollers by techniques well known in the art. Lamination heating may be done at temperatures ranging from about 95° C. to about 175° C., preferably from about 105° C. to about 175° C., at pressures ranging from about 5 psig (0.034 MPa) to about 100 psig (0.69 MPa), for from about 5 seconds to about 36 hours, preferably from about 30 seconds to about 24 hours.

Coatings of the thermoplastic polymer on the fiber layer surfaces are preferably very thin, having preferred layer thicknesses of from about 1 μm to about 250 μm, more preferably from about 5 μm to about 25 μm and most preferably from about 5 μm to about 9 μm. It should be understood, however, that these thicknesses are not necessarily descriptive of non-continuous webs. For example, SPUNFAB® net-like materials are several mils thick where material is present, but most of the web is just air. These materials are better described by their basis weight, e.g. particularly preferred is a SPUNFAB® web having a basis weight of 6 grams per square meter (gsm). The thickness of the individual fiber layers will correspond to the thickness of the individual fibers. While such thicknesses are preferred, it is to be understood that other film thicknesses may be produced to satisfy a particular need and yet fall within the scope of the present invention. The thermoplastic polymer preferably comprises from about 1% to about 25% by weight of the overall composite, more preferably from about 1% to about 17% percent by weight of the overall composite and most preferably from 1% to 12%. The percent by weight of the polymer film layers will generally vary depending on the number of fiber layers included. For example, a 6 gsm SPUNFAB® layer consists of just over 1 wt. % of a 500 gsm final product.

The thickness of the individual fabrics/composites/fiber layers will correspond to the thickness of the individual fibers and the number of fiber layers incorporated into a fabric. A preferred woven fabric will have a preferred thickness of from about 25 μm to about 600 μm per layer, more preferably from about 50 μm to about 385 μm and most preferably from about 75 μm to about 255 μm per layer. A preferred non-woven fabric, i.e. a non-woven, single-layer, consolidated network, will have a preferred thickness of from about 12 μm to about 600 μm, more preferably from about 50 μm to about 385 μm and most preferably from about 75 μm to about 255 μm, wherein a single-layer, consolidated network typically includes two consolidated plies (i.e. two unitapes). While such thicknesses are preferred, it is to be understood that other thicknesses may be produced to satisfy a particular need and yet fall within the scope of the present invention.

The fabrics/composites of the invention will have a preferred areal density of from about 20 grams/m² (0.004 lb/ft² (psf)) to about 1000 gsm (0.2 psf). More preferable areal densities for the fabrics/composites of this invention will range from about 30 gsm (0.006 psf) to about 500 gsm (0.1 psf). The most preferred areal density for fabrics/composites of this invention will range from about 50 gsm (0.01 psf) to about 250 gsm (0.05 psf). Articles of the invention comprising multiple fiber layers stacked one upon another and consolidated will further have a preferred areal density of from about 1000 gsm (0.2 psf) to about 40,000 gsm (8.0 psf), more preferably from about 2000 gsm (0.40 psf) to about 30,000 gsm (6.0 psf), more preferably from about 3000 gsm (0.60 psf) to about 20,000 gsm (4.0 psf), and most preferably from about 3750 gsm (0.75 psf) to about 15,000 gsm (3.0 psf). A typical range for composite articles shaped into helmets is from about 7,500 gsm (1.50 psf) to about 12,500 gsm (2.50 psf).

The fabrics of the invention may be used in various applications to form a variety of different ballistic resistant articles using well known techniques, including flexible, soft armor articles as well as rigid, hard armor articles. For example, suitable techniques for forming ballistic resistant articles are described in, for example, U.S. Pat. Nos. 4,623,574, 4,650,710, 4,748,064, 5,552,208, 5,587,230, 6,642,159, 6,841,492 and 6,846,758, all of which are incorporated herein by reference to the extent not incompatible herewith. The composites are particularly useful for the formation of hard armor and shaped or unshaped sub-assembly intermediates formed in the process of fabricating hard armor articles. By “hard” armor is meant an article, such as helmets, panels for military vehicles, or protective shields, which have sufficient mechanical strength so that it maintains structural rigidity when subjected to a significant amount of stress and is capable of being freestanding without collapsing. Such hard articles are preferably, but not exclusively, formed using a high tensile modulus binder material.

The structures can be cut into a plurality of discrete sheets and stacked for formation into an article or they can be formed into a precursor which is subsequently used to form an article. Such techniques are well known in the art. In a most preferred embodiment of the invention, a plurality of fiber layers are provided, each comprising a consolidated plurality of fiber plies, wherein a thermoplastic polymer is bonded to at least one outer surface of each fiber layer either before, during or after a consolidation step which consolidates the plurality of fiber plies, wherein the plurality of fiber layers are subsequently merged by another consolidation step which consolidates the plurality of fiber layers into an armor article or sub-assembly of an armor article.

The following examples serve to illustrate the invention:

### Example 1

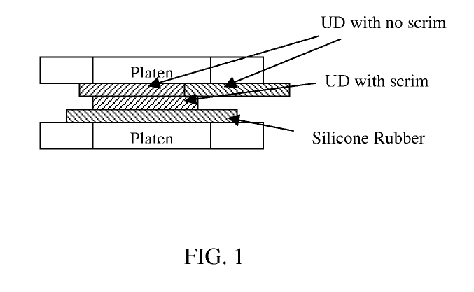

An aramid fiber-based, non-woven, unidirectional composite material (1000-denier aramid fiber; fiber areal density: 45 gsm per ply; 4-ply laminate) (0°/90°/0°/90° material; polyurethane-based matrix resin; resin content: ˜16 wt. %) containing various scrim materials bonded to its resin-poor surface was compared to a control material of identical construction but without a scrim material. Three 12″×12″ sheets of the unidirectional composite material were formed into a sub-assembly in a press using various processing conditions. FIG. 1 illustrates how the three sheets of material were arranged in the platen press, prior to subjecting them to the process conditions. The total area of pressure exerted on the material was 12″×12″. The two upper sheets of composite material were offset, which created two zones—a 1″×12″ overlapped region and a 11″×12″overlapped region, where the first upper sheet and bottom sheet contact surface area was 11″×12″, and second upper sheet and bottom sheet contact surface area was 1″×12″. Only the lower sheet for the material trials with scrim had the scrim treatment applied. To assess whether or not the surface treatment was successful, the materials were evaluated by determining whether or not the materials “tacked” together in the 1″×12″ area of overlap, or in the 11″×12″ area of overlap as illustrated in FIG. 1 when placed into a heated platen press situated with a silicone rubber sheet on the lower platen to simulate a pre-forming process at various temperatures, pressures and residence times.

The processing conditions included varying the pressure, temperature and time of the pre-forming step, followed by assessing whether or not the combination of pre-forming conditions resulted in successful tack of the material to itself. Results are shown in Table 1:

TABLE 1

| | Pressure | Temp | Time | Tack | |
|---|---|---|---|---|---|
| Product | (psi) | (° F.) | (sec) | 11″ × 12″ | Tack 1″ × 12″ |
| Control with | 150 | 125 | 30 | No (Failed) | No (Failed) |
| No Scrim | | (51.7° C.) | | | |
| Control with | 150 | 175 | 30 | Yes (Passed) | Yes (Passed) |
| No Scrim | | (79.4° C.) | | | |
| Control with | 150 | 125 | 150 | No (Failed) | No (Failed) |
| No Scrim | | (51.7° C.) | | | |
| Control with | 150 | 175 | 150 | Yes (Passed) | Yes (Passed) |
| No Scrim | | (79.4° C.) | | | |
| Control with | 325 | 150 | 90 | Yes (Passed) | No (Failed) |
| No Scrim | | (65.6° C.) | | | |
| Control with | 325 | 150 | 90 | Yes (Passed) | No (Failed) |
| No Scrim | | (65.6° C.) | | | |
| Control with | 325 | 150 | 90 | No (Failed) | No (Failed) |
| No Scrim | | (65.6° C.) | | | |
| Control with | 500 | 125 | 30 | No (Failed) | No (Failed) |
| No Scrim | | (51.7° C.) | | | |
| Control with | 500 | 125 | 150 | No (Failed) | No (Failed) |
| No Scrim | | (51.7° C.) | | | |
| Control with | 500 | 175 | 30 | Yes (Passed) | Yes (Passed) |
| No Scrim | | (79.4° C.) | | | |
| Control with | 500 | 175 | 150 | Yes (Passed) | Yes (Passed) |
| No Scrim | | (79.4° C.) | | | |
| Control + | 325 | 150 | 30 | Yes (Passed) | No (Failed) |
| Scrim 1 | | (65.6° C.) | | | |
| Control + | 325 | 150 | 90 | Yes (Passed) | Yes (Passed) |
| Scrim 1 | | (65.6° C.) | | | |
| Control + | 325 | 150 | 30 | No (Failed) | No (Failed) |
| Scrim 2 | | (65.6° C.) | | | |
| Control + | 325 | 150 | 90 | No (Failed) | No (Failed) |
| Scrim 2 | | (65.6° C.) | | | |
| Control + | 325 | 150 | 30 | Yes (Passed) | Yes (Passed) |
| Scrim 3 | | (65.6° C.) | | | |
| Control + | 325 | 150 | 90 | Yes (Passed) | Yes (Passed) |
| Scrim 3 | | (65.6° C.) | | | |

*Scrim 1 = SPUNFAB ® 100HWE 6-gsm fusible co-polyamide resin web; Melting Range, DSC (ASTM D3418) of 100° C. to 115° C.
**Scrim 2 = SPUNFAB ® 408HWG 6-gsm fusible polyolefin resin web; Stick Point (Kofler Hot Bench) (QWI-1005) of 88° C. to 98° C.
***Scrim 3 = SPUNFAB ® 308HWF 6-gsm fusible EVA resin web; Melting Range, DSC (ASTM D3418) of 120° C. to 135° C.

The above data demonstrates that the use of scrim materials beneficially allows the use lower temperatures, preferably at or below 175° F. (79.4° C.), and low pressures to process the sub-assembly.

### Example 2

A single aramid fiber-based unidirectional fiber ply coated with a polyurethane polymeric binder material is contacted while still wet with a disposable silicone-coated release paper. The wet resin distributes itself non-uniformly throughout the thickness of the unidirectional fiber web due to gravity and the difference is surface tension between the silicone-coated paper on one side and the air on the other side, causing a concentration gradient through the thickness with the filaments adjacent to the release paper being heavily saturated with resin and the filaments exposed to the air being quite resin-lean. Next, after the first ply dries, a second wet, coated aramid fiber-based fiber web coated with a polyurethane polymeric binder material is contacted at 90-degrees with the resin-lean side of the first fiber ply. This wet resin again distributes itself non-uniformly, with a higher concentration of resin at the interface of the two orthogonal fiber plies and the air-side or top-side being resin-lean. These steps are optionally repeated to produce a 4-ply non-woven structure.

### Example 3

A non-woven web of SPUNFAB® heat-activated adhesive web, commercially available from Keuchel Associates, Inc. of Cuyahoga Falls, Ohio, is attached to the composite produced according to Example 2 at 225° F. (107.2°) and 50 PSI (344.7 kPa) through a flat-bed laminator. The SPUNFAB® is added to the top side of the second 90-degree wet web while the 90-degree wet web is being laminated to the first, 0-degree web. The applied pressure is about 100 psi (689.5 kPa) but it is only applied for a split second as it is passed through a nip.

### Example 4

Examples 2 and 3 are repeated except the SPUNFAB® is added to the top side of the dry second 90-degree web as two 2-ply structures are being fed into the flat-bed laminator for consolidation into a 4-ply structure.

### Example 5

Examples 2 and 3 are repeated except the SPUNFAB® is added to the top side of an already consolidated 4-ply structure as it exits the flat-bed laminator, using the residual heat of consolidation to bond the SPUNFAB® to the surface.

### Example 6

Examples 2 and 3 are repeated except the SPUNFAB® is added with the application of an additional source of heat and pressure to bond it to the surface of a 4-ply structure.

### Example 7

A plurality of fiber layers produced according to Example 2 are fabricated, stacked together and consolidated. A thermoplastic polymer is then applied and bonded to a resin-poor surface of the resulting consolidated structure as according to Example 2. The resulting structure is then molded into a helmet sub-assembly. Other helmet sub-assemblies fabricated from the same or different materials are also prepared. Each of the sub-assemblies is fabricated by lamination at a moderate temperature and moderate pressure with a short residence time. Thereafter, all of the sub-assemblies are placed together into a final helmet mold and bonded together at a high temperature and high pressure with a long residence time to merge them and thereby produce a helmet assembly. This final assembly is then cooled under pressure and removed from the mold for further finishing processes.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A method of producing a composite impregnated with a non-uniformly distributed polymeric binder material, the method comprising:
a) providing a fiber layer having an outer top surface and an outer bottom surface, the fiber layer comprising a plurality of fiber plies, each of said fiber plies comprising a plurality of fibers, wherein the fiber layer is impregnated with a polymeric binder material;
b) applying a thermoplastic polymer onto said outer top surface of the fiber layer and/or said outer bottom surface of the fiber layer; and
c) bonding the thermoplastic polymer on the fiber layer to the fiber layer, wherein:
i) the thermoplastic polymer is bonded to the fiber layer before a consolidation step which consolidates the plurality of fiber plies and the polymeric binder material into a composite; or
ii) the thermoplastic polymer is bonded to the fiber layer in-line during a consolidation step which consolidates the plurality of fiber plies and the polymeric binder material into a composite; or
iii) the thermoplastic polymer is bonded to the fiber layer after a consolidation step which consolidates the plurality of fiber plies and the polymeric binder material into a composite.

2. The method of claim 1 wherein step c) comprises: i) bonding the thermoplastic polymer to the fiber layer before a consolidation step which consolidates the plurality of fiber plies and the polymeric binder material into a composite.

3. The method of claim 1 wherein step c) comprises: ii) bonding the thermoplastic polymer to the fiber layer in-line during a consolidation step which consolidates the plurality of fiber plies and the polymeric binder material into a composite.

4. The method of claim 1 wherein step c) comprises: iii) bonding the thermoplastic polymer to the fiber layer after a consolidation step which consolidates the plurality of fiber plies and the polymeric binder material into a composite.

5. The method of claim 1 wherein the polymeric binder material is non-uniformly distributed in the fiber layer prior to step b).

6. The method of claim 1 wherein the polymeric binder material is non-uniformly distributed in the fiber layer during or after step b) but prior to step c).

7. The method of claim 1 wherein the polymeric binder material is non-uniformly distributed in the fiber layer either during or after step c).

8. The method of claim 1 wherein the fiber layer comprises polymer-rich areas and polymer-poor areas, the polymer-rich areas comprising a greater concentration of the polymeric binder material than the polymer-poor areas.

9. The method of claim 8 wherein at least one of the outer top surface and outer bottom surface of the fiber layer are polymer-poor areas of the fiber layer.

10. The method of claim 9 wherein the thermoplastic polymer is applied onto a polymer-poor outer surface of the fiber layer.

11. The method of claim 1 wherein the thermoplastic polymer is applied to the fiber layer as an adhesive thermoplastic web, as a continuous thermoplastic adhesive film, as an ordered discontinuous thermoplastic adhesive net, as a non-woven discontinuous adhesive fabric, as a non-woven discontinuous adhesive scrim, or as a fusible powder.

12. The method of claim 1 wherein the composite comprises either an armor article or a sub-assembly of an armor article.

13. The method of claim 1 wherein a plurality of fiber layers are provided, each comprising a consolidated plurality of fiber plies, wherein a thermoplastic polymer is bonded to at least one outer surface of each fiber layer either before, during or after a consolidation step which consolidates the plurality of fiber plies, wherein the plurality of fiber layers are subsequently merged by another consolidation step which consolidates the plurality of fiber layers into a complex composite.

14. The method of claim 13 wherein the complex composite comprises either an armor article or a sub-assembly of an armor article.

15. A composite material comprising at least one fiber layer having an outer top surface and an outer bottom surface, which fiber layer comprises a plurality of fiber plies, said fiber plies each comprising a plurality of fibers having a polymeric binder material thereon, and wherein the polymeric binder material is non-uniformly distributed in the fiber layer; and a thermoplastic polymer bonded to said outer top surface of the fiber layer and/or said outer bottom surface of the fiber layer.

16. The composite material of claim 15 wherein the fiber layer comprises polymer-rich areas and polymer-poor areas, the polymer-rich areas comprising a greater concentration of the polymeric binder material than the polymer-poor areas.

17. The composite material of claim 16 wherein at least one of the outer top surface and outer bottom surface of the fiber layer are polymer-poor areas of the fiber layer, and the thermoplastic polymer is bonded to the polymer-poor surface.

18. The composite material of claim 15 wherein the thermoplastic polymer comprises an adhesive thermoplastic web, a continuous thermoplastic adhesive film, an ordered discontinuous thermoplastic adhesive net, a non-woven discontinuous adhesive fabric, a non-woven discontinuous adhesive scrim, or an adhesive melted powder.

19. The composite material of claim 15 which comprises a consolidated plurality of fiber layers, each comprising a consolidated plurality of fiber plies, wherein a thermoplastic polymer is applied and bonded to at least one outer surface of each fiber layer.

20. An armor article or sub-assembly of an armor article formed from the composite of claim 15.
